(19) United States
(12) Patent Application Publication
(10) Pub. No.: US 2009/0091776 A1
(43) Pub. Date: Apr. 9, 2009

(54) Image Transmission Apparatus, Image Transmission Method, And Image Transmission Program

(75) Inventors: Minako Kobayashi, Osaka (JP); Hirohisa Miyamoto, Kobe-shi (JP); Takehisa Yamaguchi, Ikoma-shi (JP); Katsuhiko Akita, Amagasaki-shi (JP); Okihisa Yoshida, Amagasaki-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 12/246,902

(22) Filed: Oct. 7, 2008

(30) Foreign Application Priority Data
Oct. 9, 2007 (JP) 2007-263411

(51) Int. Cl. G06F 3/12

(52) U.S. Cl. 358/1.13

(57) ABSTRACT

An image transmission apparatus includes a storage part that stores previous transmission methods; a receiving part that receives a destination name from a sender (S4); an obtaining part that obtains, from the address server computer, a new transmission method registered in association with the received destination name (S10); an extracting part that extracts the previous transmission method stored in association with the received destination name (S13); and a selection part that has a sender select one of the obtained new transmission method and the extracted previous transmission method (S20). The image transmission apparatus resolves problems such as a high communication charge being incurred or an image being unable to be transmitted as intended by the sender without a sender realizing, in an environment where recipients can each arbitrarily select a destination according to a setting.

This application is based on application No. 2007-263411 filed in Japan, the content of which is hereby incorporated by reference.

### BACKGROUND OF THE INVENTION

(1) Field of the Invention

The present invention relates to an image transmission apparatus, and in particular to a technique for improving usability when selecting a destination.

(2) Description of the Related Art

In an MFP (Multi Function Peripheral) that consolidates the functions of a plurality of apparatuses such as a scanner, a printer, a copier, a FAX and the like into one apparatus, it is bothersome for a user to have to input a destination each time he or she transmits image data For this reason, clients and the like are registered in an address book which is stored in advance in the MFP itself or in an address server or the like, and when transmitting image data, the user is able to call this address book and designate a destination from the address book. This eliminates the effort of inputting the destination.

Here, when a destination of a client or the like changes, it is necessary for the administrator of the MFP, the address server or the like to manually change the destination in the address book after finding out about the change. This is problematic in terms of promptness and operability.

Techniques such as the following deal with this problem by updating an address book promptly and automatically.

Patent document 1 (Japanese Unexamined Patent Application Publication No. 2003-108479) discloses a technique whereby an address book is put in association profiles of destinations in a specific server, and then when there is a change in a profile, the address book data is automatically updated in accordance with the change in the profile. Patent Document 1 recites that this technique has the effect of enabling the address book data of an associated party to be updated by a user changing the profile.

Patent Document 2 (Japanese Unexamined Patent Application Publication No. 2003-244308) discloses a technique that enables an address book to be used via the Internet, and recites that this technique lightens the labor for physically registering, revising and deleting in individual devices.

Patent Document 3 (Japanese Unexamined Patent Application Publication No. 2005-33733) discloses the following technique. A change in the address of the user of a first terminal is instructed through the first terminal. The address of the user instructed through the first terminal is changed in a server. The user address changed in the server is then automatically changed in a corresponding address book in a second terminal Patent Document 3 recites that this technique greatly lightens the burden on the users because neither the user of the first terminal nor the user of the second terminal is forced to carry out a bothersome procedure, and at the same time enables the addresses in the address book to always be kept current. In addition, inadvertent leaking of new addresses is also prevented.

Patent Document 4 (Japanese Unexamined Patent Application Publication No. 2006-20049) discloses a technique whereby a change is detected in destination information of a communication partner registered in an address book and in a DNS server, and then the destination information is automatically updated in an address book in correspondence with the change in the destination information in the DNS server. Patent Document 4 recites that this technique reduces the burden of organizing the address book, and prevents communication from being performed unnecessarily for reasons such as not being able to connect.

The present invention assumes an image transmission system in which each individual recipient has a plurality of destinations, and each recipient can select a destination arbitrarily according to a setting. In such a system, if destinations of image data are permitted to be updated automatically and unconditionally as in Patent Documents 1 to 4, various problems may occur that prevent images from being transmitted as intended by the sender without the sender realizing. For instance, extremely high communication charges may be incurred, insufficient resolution may be designated by a transmission method set as a result of changing the destination information, or a color image may be unable to be transmitted in color.

### SUMMARY OF THE INVENTION

The present invention was conceived in order to resolve such problems, and has an object of providing an image transmission apparatus, an image transmission method and an image transmission program that resolve problems such as incurring high communication costs and an image being unable to be sent as intended by a sender without the sender realizing, as the result of a change in a destination of a recipient in an environment in which a destination can be selected arbitrarily by a user according to a setting

In order to achieve the stated object, an aspect of the present invention is an image transmission apparatus for transmitting image data in accordance with a transmission method registered in association with a destination name in an address server computer connected over a network, the image transmission apparatus including: a storage part operable to store a plurality of previous transmission methods in association with a plurality of destination names; a receiving part operable to receive a destination name from a sender; an obtaining part operable to obtain, from the address server computer, a new transmission method registered in association with the received destination name; an extracting part operable to extract the previous transmission method stored in association with the received destination name from the storage part; a selection part operable to have a sender select one of the obtained new transmission method and the extracted previous transmission method; and a transmitting part operable to transmit the image data in accordance with the selected transmission method.

In order to achieve the stated object, another aspect of the present invention is an image transmission method used in an image transmission apparatus for transmitting image data in accordance with a transmission method registered in association with a destination name in an address server computer connected over a network, the image transmission apparatus including a storage part operable to store a plurality of previous transmission methods in association with a plurality of destination names, and the image transmission method including the steps of: receiving a destination name from a sender; obtaining, from the address server computer, a new transmission method registered in association with the received destination name; extracting the previous transmission method stored in association with the received destination name from the storage part; having a sender select one of the obtained new transmission method and the extracted previous transmission method; and transmitting the image data in accordance with the selected transmission method.

In order to achieve the stated object, yet another aspect of the present invention is an image transmission program that causes an image transmission apparatus to perform image transmission processing, the image transmission apparatus being for transmitting image data in accordance with a transmission method registered in association with a destination name in an address server computer connected over a network, and including a storage part operable to store a plurality of previous transmission methods in association with a plurality of destination names, and the image transmission program causing the image transmission apparatus to perform the steps of: receiving a destination name from a sender; obtaining, from the address server computer, a new transmission method registered in association with the received destination name; extracting the previous transmission method stored in association with the received destination name from the storage part; having a sender select one of the obtained new transmission method and the extracted previous transmission method; and transmitting the image data in accordance with the selected transmission method.

According to the stated structure, method and program, when a transmission method has been updated, a sender can select one of the old transmission method and the new transmission method. This prevents problems such as communication charges increasing and image data not being able to be transmitted as intended by the sender occurring without the sender knowing.

Here, the selection part may include: a notification sub-part that (a) either stores therein a communication charge for each transmission method or has a function of calculating a communication charge for each transmission method, and (b) is operable to, if a communication charge for the obtained new communication method is more expensive than a communication charge for the extracted previous communication method, notify the sender to such effect.

According to the stated structure, the sender is notified when the transmission method is to be changed to a transmission method for which the communication charge is expensive. This avoids a situation in which a higher communication charge is incurred without the user knowing.

Here, the notification sub-part may be further operable to notify the sender of a reason that the communication charge for the obtained new communication method is more expensive than the communication charge for the extracted previous communication method.

According to the stated structure, the sender is notified when the transmission condition is to be changed. This avoids a situation in which the transmission condition is changed without the user knowing and the image data cannot be transmitted as intended by the sender

Here, each transmission method may include (i) information specifying a destination and (ii) a transmission condition relating to quality of an image to be transmitted, and the selection part may include: a notification sub-part operable to, if the transmission condition designated by the obtained new transmission method is different to the extracted previous transmission method, notify the sender to such effect.

According to the stated structure, when notifying the sender that the transmission method is to be changed to a transmission method for which the communication charge is expensive, or notifying the sender that the communication condition is to be changed, the reason is also presented. Therefore, the sender can select either the new transmission method or the previous transmission method more accurately based on the reason presented.

Here, the notification sub-part may be further operable to notify the sender of a reason that the transmission condition of the obtained new transmission method is different to the extracted previous transmission method.

According to the stated structure, the new transmission method is forcedly selected when the communication charge is not more expensive and the transmission condition is equivalent. Therefore, as long as problems such as the communication charge increasing or the image data not being able to be transmitted as intended by the user do not occur, the sender does not have to select the transmission method. This improves convenience without disadvantage to the sender.

Here, each transmission method may include (i) information specifying a destination and (ii) a transmission condition relating to quality of an image to be transmitted, and the selection part may (a) either store therein a communication charge for each transmission method, or has a function of calculating a communication charge for each transmission method, and (b) may be further operable to, if the transmission charge for the obtained new transmission method is equal to or less expensive than the communication charge for the extracted previous transmission method, and if the transmission condition for the obtained new transmission method is equivalent to the transmission condition for the extracted previous transmission method, forcedly select the obtained new transmission method and rewrite, with the new transmission method, the previous transmission method stored in association with the received destination name in the storage part.

According to the stated structure, in the case of a setting to always give priority to the new transmission method, the new transmission method is forcedly selected. Having this setting activated for trusted destinations improves convenience without disadvantage to the sender, and is useful for a sender who simply wishes not to have to select a transmission method.

Here, the transmission method may include, in association with each destination name, a setting showing whether or not to always give preference to the new transmission method, and the selection unit may be further operable to, if the setting in association with the received destination name shows that the new transmission method should always be given preference to, forcedly select the obtained new transmission method and rewrite, with the new transmission method, the previous transmission method stored in association with the received destination name in the storage part.

According to the stated structure, the sender can use manual input to directly input information specifying a destination. This increases flexibility of selection for the sender

Here, the image transmission apparatus may further include: a manual input part operable to receive information specifying a destination directly according to a manual input by the sender, wherein the transmission part, when the manual input part receives the information, transmits the image data in accordance with the information.

According to the stated structure, when a setting is not made to follow the user setting, and the personal address book is followed. This improves convenience because the sender can set which of the recipient setting and the personal address book is to be followed.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 shows an overview of an entire image transmission system in an embodiment of the present invention;

FIG. 2 shows an overview of the structure of an image transmission apparatus 1;

FIG. 3 shows an overview of the structure of an address server 2;

FIG. 4 shows the procedure for processing to transmit image data by the image transmission apparatus 1 of the present embodiment;

FIG. 5 shows a display example of the list of destination names;

FIG. 6 shows a display example of a communication charge warning screen;

FIG. 7 shows a display example of a transmission condition warning screen; and

FIG. 8 shows a display example of a transmission method selection screen.

### DESCRIPTION OF THE PREFERRED EMBODIMENTS

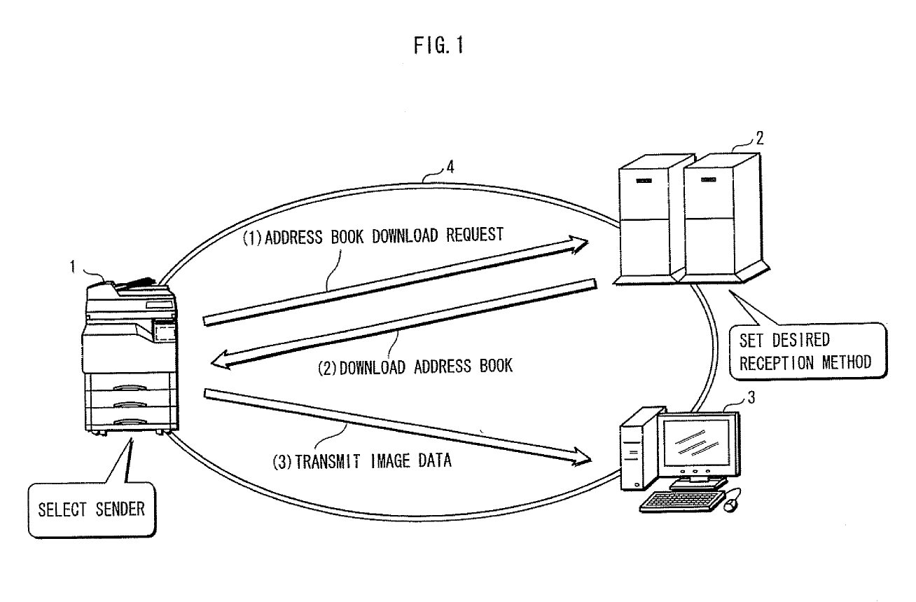

FIG. 1 shows an overview of an image transmission system in an embodiment of the present invention.

As shown in FIG. 1, the image transmission system of the present embodiment includes an image transmission apparatus 1, an address server 2 (server computer), a personal computer 3, and a network 4. Note that although for simplicity of explanation only one of each apparatus is shown, ordinarily the number of apparatuses is different to this. For instance, although the image transmission system may include only one or a few address servers 2 at the most and all of these may operate as one, the image transmission system ordinarily includes numerous image transmission apparatuses 1 and personal computers 3, that have equivalent functions to each other and operate independently of each other.

The image transmission apparatus 1 is, for instance, an MFP, and has a function of transmitting image data generated by scanning a document, image data stored therein, or image data transmitted from the personal computer of a sender. The image transmission apparatus 1 is capable of transmitting the image data in various ways such as facsimile or email.

FIG. 1 shows (1) the image transmission apparatus 1 making a download request to the address server 2 for a personal address book and an auto address book, (2) data of the personal address book and data of the auto address book being downloaded to the image transmission apparatus 1 from the address server 2 based on the request, the sender selecting a destination for image data mainly from the downloaded personal address book and auto address book, and (3) the image data being transmitted to the personal computer 3 of the selected destination.

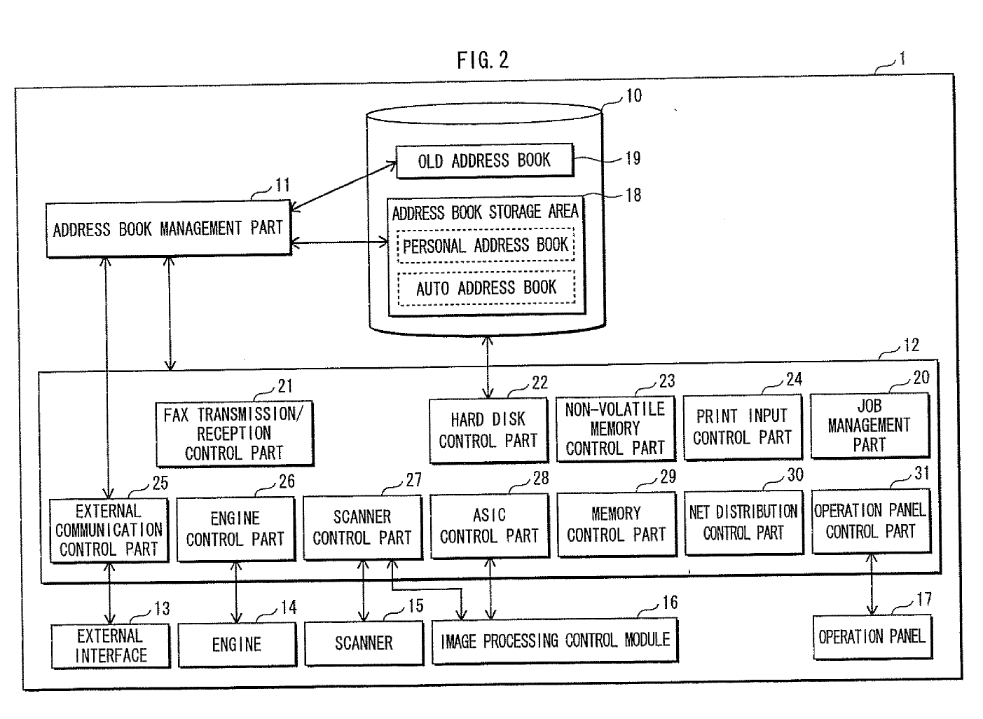

FIG. 2 shows an overview of the structure of the image transmission apparatus 1.

As shown in FIG. 2, the image transmission apparatus 1 of the present embodiment is composed of a storage part 10, an address book management part 11, a controller 12, an external interface 13, an engine 14, a scanner 15, an image processing control module 16, and an operation panel 17.

Here, each of the external interface 13, the engine 14, the scanner 15, the image processing control module 16, the operation panel 17 and such is a function unit that achieves its functions by being controlled by the controller 12. Note that these function units are conventional technology, and therefore a description thereof is omitted.

The storage part 10 is a storage medium such as a hard disk drive, and stores various image data such as image data generated by scanning a document and image data received from an external source. The storage part 10 includes an address book storage area 18 for storing data of a personal address book, data of an auto address book, or the like, received over the network 4 The storage part 10 also stores a list of previous transmission methods in association with destination names. This list is stored as an old address book 19. Here, the personal address book is a list of names and transmission methods in association, the names being names of destination candidates as customized by senders. The auto address book is a list of names of destination candidates who have registered a recipient setting. Here, each name of a destination candidate is a proper noun, or a limiting element thereof, for specifying the destination candidate, such as a personal name, a company name, a professional affiliation, and title of the destination candidate. Furthermore, a recipient setting refers to a user pre-registering, in the address server 2, a reception method that is a convenient way for him/her to receive image data. This makes it possible for a sender, when transmitting image data in accordance with the recipient setting, to transmit the image data to a destination that is thought to be the most convenient by the recipient using a transmission method that conforms with the preferences of the recipient.

The address book management part 11 downloads data of a personal address book from the address server 2 and stores the downloaded data of the address book in the address book storage area 18. More specifically, based on the user ID of a user who has logged in, the address book management part 11 downloads data of the personal address book of the user with a predetermined timing, which may be directly after the user logs in. The personal address book is displayed on the operation panel, and a destination is selected therefrom by the user (hereinafter referred to as the sender). Upon the selection being received from the user, the address book management part 11 extracts the corresponding transmission method from the data of the personal address book, and has the image data sent in accordance with the extracted transmission method. Here, if a “follow recipient setting” setting has been made in the transmission method extracted from the data of the personal address book, the address book management part 11 downloads a new reception method designated by the recipient setting registered in correspondence with the received destination name from the address server 2. The address book management part 11 also extracts the previous transmission method stored in association with the received destination name from the old address book 19, has the user select a transmission method from among the new transmission method and the previous transmission method, and transmits the image data according to the selected transmission method. Note that details of image data transmission are given later.

When an instruction is received from the sender to display the auto address book, the address book management part 11 downloads data of the auto address book from the address server 2, and stores the data of the auto address book in the address book storage area 18. The auto address book is then displayed on the operation panel, and a destination name is selected therefrom by the sender. Upon the selection being received, the address book management part 11 downloads the new reception method designated by the recipient setting registered in association with the received destination name, and transmits the image data in accordance with the new reception method

The controller 12 is composed of control software, and hardware such as a CPU or a work memory, and includes a job management part 20 that manages the job execution order, data of each job, and such. The controller 12 also includes function-specific control parts, each of which controls the operations and the like of a corresponding one of the function units These function-specific control parts include a FAX transmission/reception control part 21, a hard disk control part 22, a non-volatile memory control part 23, a print input control part 24, an external communication control part 25, an engine control part 26, a scanner control part 27, an ASIC control part 28, a memory control part 29, a network distribution control part 30, and an operation panel control part 31. Note that these function-specific control parts are conventional technology, and therefore a description thereof is omitted.

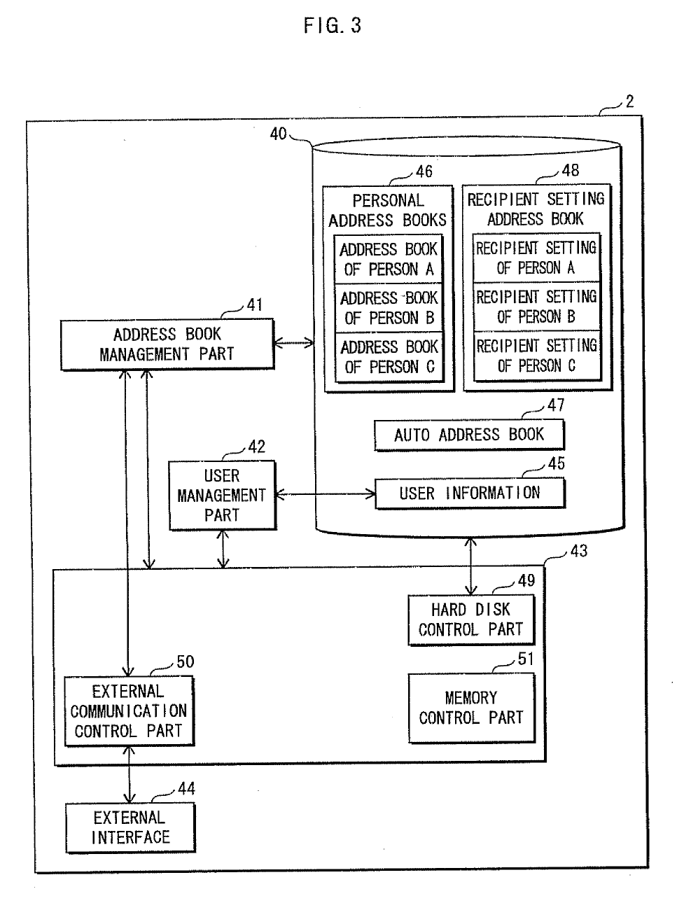

FIG. 3 shows an overview of the structure of the address server 2.

As shown in FIG. 3, the address server 2 in the present embodiment is composed of a storage part 40, and address book management part 41, a user management part 42, a controller 43, and an external interface 44.

Here, the external interface 44 is a function unit that realizes its functions by being controlled by the controller 43. Note that the function units are conventional technology, and therefore a description thereof is omitted.

The storage part 40 is a storage medium such as a hard disk drive, and stores user information 45, a personal address book 46, an auto address book 47, and a recipient setting address book 48. Here, the user information 45 may be information relating to each user, or authentication-use data such as a password or a login name necessary for login authentication. Furthermore, the recipient setting address book 48 is a list of recipient settings registered by users from the point of view of being a recipient.

The address book management unit 41 manages the personal address book 46, the auto address book 47 and the recipient setting address book 48 stored in the storage part 40 Upon receiving a request from the image transmission apparatus 1, the address book management unit 41 transmits the personal address book 46 and the auto address book 47 to have them downloaded. Upon receiving a registration of a user setting from a user, the address book management unit 41 updates the auto address book 47 and the recipient setting address book 48. Furthermore, when a recipient is selected from the personal address book 46 by a sender in the image transmission apparatus 1, and the corresponding transmission method in the personal address book 46 is set as “follow recipient setting”, or when the recipient is selected from the auto address book 47, the address book management unit 41 transmits the new recipient setting registered in association with the selected transmission name in the recipient setting address book 48, to the image transmission apparatus 1 to have the new recipient setting downloaded to the image transmission apparatus 1.

The user management part 42 manages users by carrying out functions such as authentication processing using the user information 45 stored in the storage part 40, in response to a request for login authentication from the image transmission apparatus 1.

The controller 43 is composed of control software and hardware such as a CPU or a work memory, and includes function-specific control parts, specifically, a hard disk control part 49, an external communication control part 50, a memory control part 51, and so on. Note that these function-specific control parts are conventional technology, and therefore a description thereof is omitted.

Operations

FIG. 4 shows the procedure for processing to transmit image data by the image transmission apparatus 1 of the present embodiment.

The following describes procedure for processing to transmit image data with use of FIG. 4.

(1) The image transmission apparatus 1 waits until a user logs in (step S1).

(2) When a user logs in, the image transmission apparatus 1 obtains data of the personal address book of the user from the address server 2, and stores the obtained data of the personal address book in the storage part 10 (step S2).

(3) The image transmission apparatus 1 displays a list of the destination names registered in data of the personal address book in the storage part 10, on a liquid crystal display portion or the like of the liquid crystal panel, and prompts the user to select a destination name (step S3).

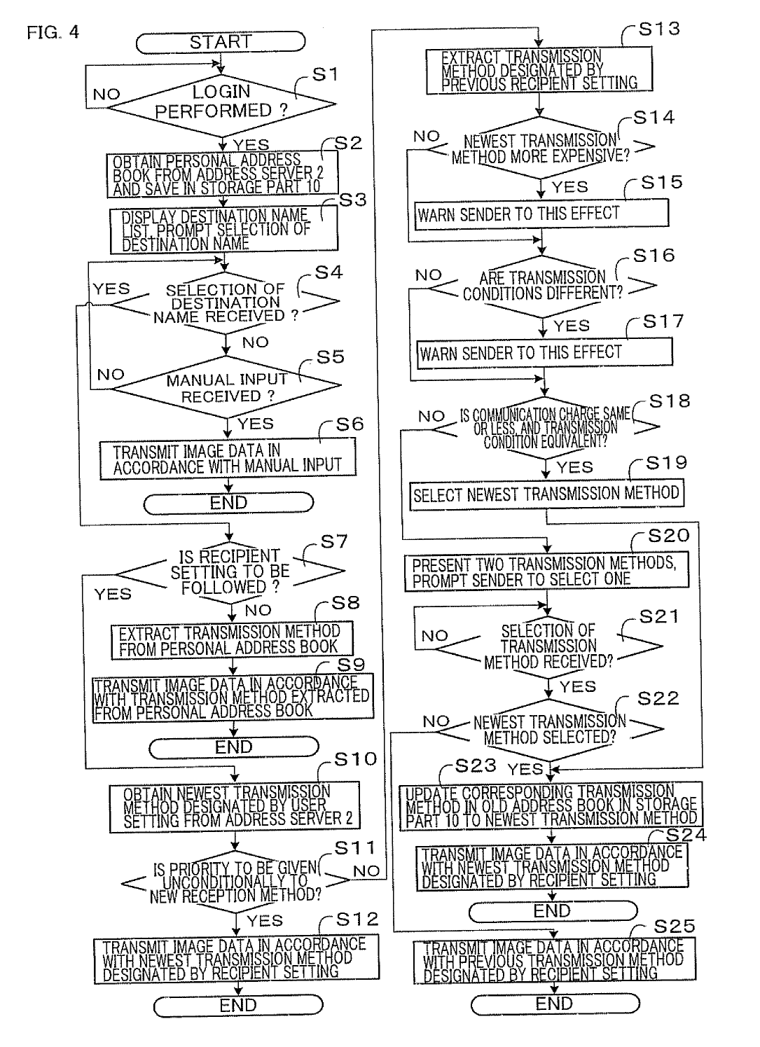

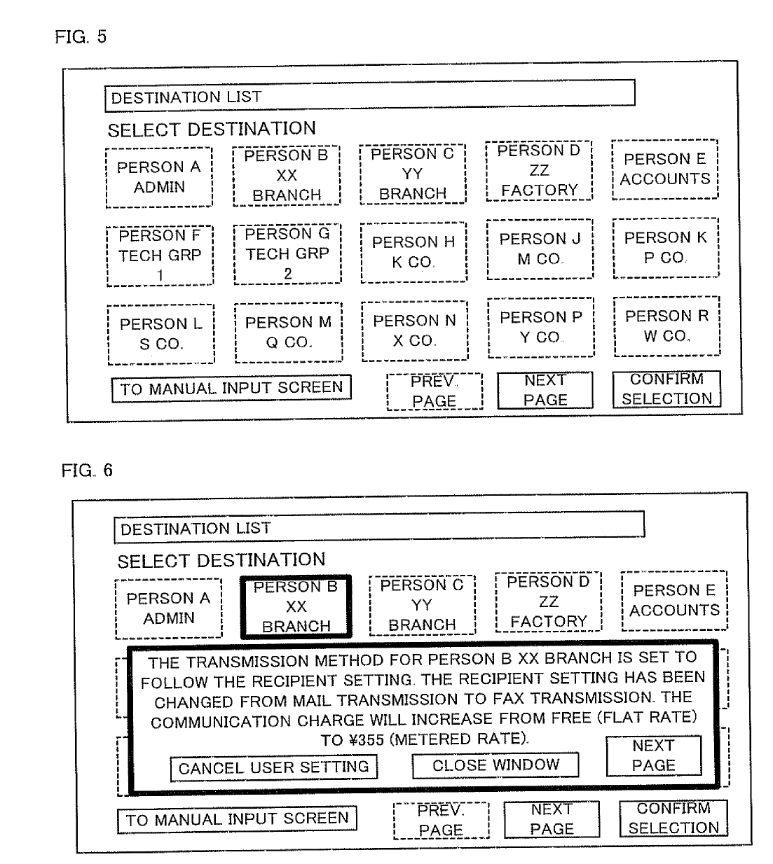

FIG. 5 shows a display example of the list of destination names in step S3.

(4) The image transmission apparatus 1 waits to receive a selection of a destination name from the user (the sender) (step S4).

(5) The image transmission apparatus 1 waits to receive an input of information specifying a destination, such as a FAX number, by direct manual input through the operation panel or the like (step S5).

(6) Upon receiving a manual input of information specifying a destination, the image transmission apparatus 1 transmits image data in accordance with the information (step S6).

(7) Upon receiving the selection of the destination name, the image transmission apparatus 1 refers to data of the personal address book in the storage part 10 to judge whether or not “follow recipient setting” is set for the received destination name (step S7).

(8) When “follow recipient setting” is not set, the image transmission apparatus 1 extracts the transmission method stored in association with the destination name at step S4 from the data of the personal address book stored in the storage part 10 at step S2 (step S8).

(9) The image transmission apparatus 1 transmits the image data in accordance with the transmission method extracted from the data of the personal address book at step S8 (step S9).

(10) When “follow recipient setting” is set, the image transmission apparatus 1 obtains, from the address server 2, the new transmission method designated by the recipient setting registered in association with the destination name received at step S4 (step S10).

(11) The image transmission apparatus 1 refers to data of the personal address book in the storage part 10 to judge whether or not a setting is made with respect to the destination name received at step S4 to give priority unconditionally to the new recipient setting (step S11).

(12) When a setting is made to give priority unconditionally to the new recipient setting, the image transmission apparatus 1 transmits image data in accordance with the new transmission method designated by the recipient setting obtained at step S10 (step S12).

(13) When a setting is not made to give priority unconditionally to the new recipient setting, the image transmission apparatus 1 extracts, from data of the old address book that stores the transmission methods designated by the previous recipient setting associated with the destination names originally stored in the storage unit 10, the transmission method designated by the previous recipient setting registered in association with the destination name received at step S4 (step S13).

(14) The image transmission apparatus 1 judges which is the more expensive of (a) a communication charge using the newest transmission method obtained from the address server 2 in step S10 and (b) a communication charge using the previous transmission method extracted from the storage unit 10 at step S13 (step S14). The image transmission apparatus 1 makes this judgment either based on communication charges stored therein with respect to each transmission method, or using a communication charge calculation function provided either in the image transmission apparatus itself or in another device connected to the image transmission apparatus 1 over a network

(15) When the communication charge using the newest transmission method is more expensive than the communication charge using the previous transmission method, the image transmission apparatus 1 notifies the sender to this effect and also presents the reason for this to the sender by, for instance, displaying the communication charges or the difference in the communication charges on the liquid crystal display portion or the like of the operation panel (step S15).

As one example, if there is a flat rate for mail transmission whereby each individual mail transmission is substantially free, and the transmission method is changed from mail transmission to fax transmission, the image transmission apparatus 1 judges that the communication charge has been changed to an expensive charge. The image transmission apparatus 1 displays notification to this effect, as well as displaying a communication charge calculated from a network usage amount per unit of time, a data amount of the image data and a network speed.

As a further example, in the case of the fax number simply being changed, the image transmission apparatus 1 calculates communication charge for both the old and new fax numbers based on the respective network usage amount per unit of time, data amount of the image data and network speed, and compares the two calculated communication charges. The image transmission apparatus 1 then judges which of the communication charges is the more expensive, and if the communication charge is more expensive for the new fax number, also displays the two calculated communication charges.

In particular, the image transmission apparatus 1 may be structured such that the user is always notified in the case of the fax number having been changed from a domestic number to an international number, or in the case of the communication charge being unable to be determined due to a lack of information regarding charges after the change.

FIG. 6 shows a display example of a communication charge warning screen in step S15.

(16) The image transmission apparatus 1 judges whether (a) a transmission condition for the newest transmission method obtained from the address server 2 at step S10 and (b) a transmission condition for the previous transmission method extracted from the storage part 10 at step S13 are different (step S16).

(17) When the transmission condition for the newest transmission method and the transmission condition for the previous transmission method are different, the image transmission apparatus 1 notifies the sender to this effect and also presents the reason for this to the sender by, for instance, displaying the transmission conditions on the liquid crystal display portion or the like of the operation panel (step S17).

As one example, take the case of a user attempting to change a communication condition from being one that permits color transmission to be a communication condition such as a G3 fax by which transmission can be performed only in monochrome. There is a risk of a drop in image quality in this case. Furthermore, if a user attempts to change the transmission method from fax transmission to mail transmission, there is a risk of a drop in security. If the user attempts to designate a highly compressed file (for example, a highly compressed PDF or a highly compressed XPS) it will be necessary to use network scan distribution. This will exclude mail transmission when delivery confirmation is desired or in the case of a large amount of data.

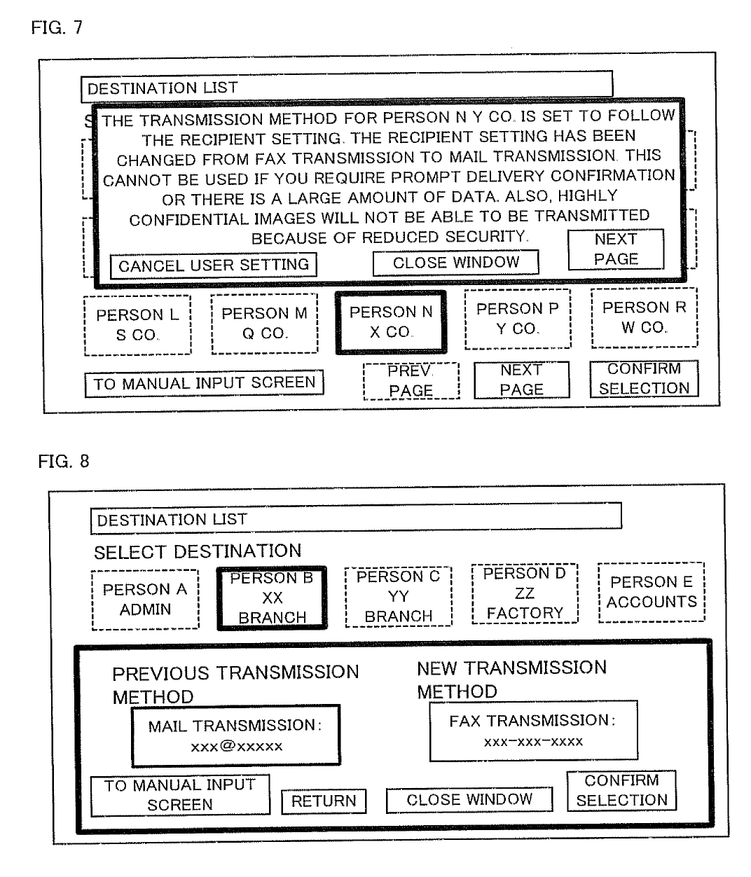

FIG. 7 shows a display example of a transmission condition warning screen in step S15.

(18) The image transmission apparatus 1 judges whether the communication charge for the newest transmission method is the same or less expensive than the communication charge for the previous transmission method, and whether the transmission condition for the new transmission method is equivalent to the transmission condition for the previous transmission method (step S18).

(19) When the communication charge is the same or less expensive, and the transmission condition is equivalent, the image transmission apparatus 1 automatically selects the newest transmission method from among the two transmission method (step S19).

(20) When the communication charge is not the same or less expensive, and the transmission condition is not the same, the image transmission apparatus 1 presents the two transmission methods as alternatives on the liquid crystal display portion or the like of the operation panel, and prompts the sender to make a selection (step S20).

FIG. 8 shows a display example of a transmission method selection screen in step S20.

(21) The image transmission apparatus 1 wait to receive a selection of a transmission method (step S21).

(22) The image transmission apparatus 1 judges whether or not the newest transmission method has been selected (step S22).

(23) When the newest transmission method has been selected, the image transmission apparatus 1 updates the corresponding transmission method in the data of the old address book in the storage part 10 to the selected newest transmission method (step S23).

(24) The image transmission apparatus 1 transmits the image data in accordance with the selected newest transmission method (step S24).

(25) When the previous transmission method is selected rather than the newest transmission method, the image transmission apparatus 1 transmits the image data in accordance with the previous transmission method (step S25).

Note that in the present embodiment at step S11 the image transmission apparatus 1 judges whether or not a setting is made to give priority unconditionally to the new recipient setting, and at step S12 the image data is transmitted in accordance with the new transmission method designated by the recipient setting. However, conversely, the image transmission apparatus 1 may judge whether or not a setting is made to give priority unconditionally to the previous recipient setting, and transmit the image data in accordance with the previous transmission method designated by the recipient setting.

Furthermore, although the old address book 19 is stored in the storage part 10 in the image transmission apparatus 1 in the present embodiment, the old address book 19 may be stored and centrally administered in the address server 2, and the image transmission apparatus 1 may use the old address book 19 by downloading it when downloading data of a personal address book or when necessary

Conclusion

As has been described, according to the present embodiment, in an environment where a destination can be arbitrarily selected by a recipient according to recipient settings, a sender can select a transmission method from among a new transmission method and a previous transmission method if a recipient has updated the transmission method. This prevents problems such as communication charges increasing and image data not being able to be transmitted as the sender intends occurring without the sender knowing.

A program capable of causing a computer to execute operations of the present embodiment may be recorded on a computer-readable recording medium, and the recording medium may be subjected to distribution and trade. Furthermore, the program may be distributed via a network and subjected to trade, or may be presented to a user by being displayed on a display apparatus or by being printed.

Here, the computer-readable recording medium may be a detachable recording medium such as a loppy disk, a CD (compact disk), an MO (mobile optical), a DVD (digital versatile disk) or a memory card, or may be a fixed recording medium such as a hard disk or a semiconductor memory, but is not limited to any type of recording medium in particular.

### INDUSTRIAL APPLICABILITY

The present invention can be widely applied to a technical field of image transmission apparatuses including MFPs and the like.

The present invention allows image data to be transmitted taking the intentions of the recipient into account while also avoiding detriment to the sender. Therefore, the present invention provides an image transmission apparatus that is highly convenient and usable by users, and has extremely high usage potential in industry.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

What is claimed is:

1. An image transmission apparatus for transmitting image data in accordance with a transmission method registered in association with a destination name in an address server computer connected over a network, the image transmission apparatus comprising:
a storage part operable to store a plurality of previous transmission methods in association with a plurality of destination names;
a receiving part operable to receive a destination name from a sender;
an obtaining part operable to obtain, from the address server computer, a new transmission method registered in association with the received destination name;
an extracting part operable to extract the previous transmission method stored in association with the received destination name from the storage part;
a selection part operable to have a sender select one of the obtained new transmission method and the extracted previous transmission method; and
a transmitting part operable to transmit the image data in accordance with the selected transmission method.

2. The image transmission apparatus of claim 1, wherein
the selection part includes:
a notification sub-part that (a) either stores therein a communication charge for each transmission method or has a function of calculating a communication charge for each transmission method, and (b) is operable to, if a communication charge for the obtained new communication method is more expensive than a communication charge for the extracted previous communication method, notify the sender to such effect.

3. The image transmission apparatus of claim 2, wherein
the notification sub-part is further operable to notify the sender of a reason that the communication charge for the obtained new communication method is more expensive than the communication charge for the extracted previous communication method.

4. The image transmission apparatus of claim 1, wherein
each transmission method includes (i) information specifying a destination and (ii) a transmission condition relating to quality of an image to be transmitted, and
the selection part includes:
a notification sub-part operable to, if the transmission condition designated by the obtained new transmission method is different to the extracted previous transmission method, notify the sender to such effect.

5. The image transmission apparatus of claim 4, wherein
the notification sub-part is further operable to notify the sender of a reason that the transmission condition of the obtained new transmission method is different to the extracted previous transmission method.

6. The image transmission apparatus of claim 1, wherein
each transmission method includes (i) information specifying a destination and (ii) a transmission condition relating to quality of an image to be transmitted, and
the selection part (a) either stores therein a communication charge for each transmission method, or has a function of calculating a communication charge for each transmission method, and (b) is further operable to, if the transmission charge for the obtained new transmission method is equal to or less expensive than the communication charge for the extracted previous transmission method, and if the transmission condition for the obtained new transmission method is equivalent to the transmission condition for the extracted previous transmission method, forcedly select the obtained new transmission method and rewrite, with the new transmission method, the previous transmission method stored in association with the received destination name in the storage part.

7. The image transmission apparatus of claim 1, wherein
the transmission method includes, in association with each destination name, a setting showing whether or not to always give preference to the new transmission method, and
the selection unit is further operable to, if the setting in association with the received destination name shows that the new transmission method should always be given preference to, forcedly select the obtained new transmission method and rewrite, with the new transmission method, the previous transmission method stored in association with the received destination name in the storage part.

8. The image transmission apparatus of claim 1, further comprising:
a manual input part operable to receive information specifying a destination directly according to a manual input by the sender,
wherein the transmission part, when the manual input part receives the information, transmits the image data in accordance with the information.

9. The image transmission apparatus of claim 1, wherein
the previous transmission method stored in the storage part is a previous transmission method designated by a recipient setting,
the new transmission method obtained by the obtaining part is a new transmission method designated by a recipient setting, and
the image transmission apparatus further comprises:
an acquisition part operable to acquire data of a personal address book personalized by the sender,
wherein, in the personal address book, in association with each destination name is (i) a transmission method set by the sender and (ii) a setting of whether or not to follow a recipient setting,
the selection part, when the received destination name is in association with a setting to not follow the recipient setting, prohibits both the obtained new transmission method and the extracted previous transmission method from being selected by the sender, and
the transmission part transmits the image data in accordance with the transmission method set by the sender in association with the received destination name in the personal address book.

10. An image transmission method used in an image transmission apparatus for transmitting image data in accordance with a transmission method registered in association with a destination name in an address server computer connected over a network,
the image transmission apparatus including a storage part operable to store a plurality of previous transmission methods in association with a plurality of destination names, and
the image transmission method comprising the steps of:
receiving a destination name from a sender;
obtaining, from the address server computer, a new transmission method registered in association with the received destination name;
extracting the previous transmission method stored in association with the received destination name from the storage part;
having a sender select one of the obtained new transmission method and the extracted previous transmission method; and
transmitting the image data in accordance with the selected transmission method.

11. An image transmission program that causes an image transmission apparatus to perform image transmission processing, the image transmission apparatus being for transmitting image data in accordance with a transmission method registered in association with a destination name in an address server computer connected over a network, and including a storage part operable to store a plurality of previous transmission methods in association with a plurality of destination names, and
the image transmission program causing the image transmission apparatus to perform the steps of:
receiving a destination name from a sender;
obtaining, from the address server computer, a new transmission method registered in association with the received destination name;
extracting the previous transmission method stored in association with the received destination name from the storage part;
having a sender select one of the obtained new transmission method and the extracted previous transmission method; and
transmitting the image data in accordance with the selected transmission method.
